(19) United States
(12) Patent Application Publication
(10) Pub. No.: US 2023/0098319 A1
(43) Pub. Date: Mar. 30, 2023

(54) METHOD AND SYSTEM FOR TRACKING OBJECTS IN AREA

(71) Applicant: Darvis Inc., San Francisco, CA (US)

(72) Inventor: Jan-Philipp Mohr, Hamburg (DE)

(21) Appl. No.: 17/487,300

(22) Filed: Sep. 28, 2021

(51) Int. Cl. G06T 7/20; G06K 9/20; G06K 9/00; G06K 9/62; G06N 20/00; G06F 3/0482

(52) U.S. Cl. CPC G06T 7/20; G06K 9/2081; G06K 9/00671; G06K 9/6256; G06N 20/00; G06F 3/0482

(57) ABSTRACT

A method for tracking objects in an area is provided. The method comprises receiving a camera frame providing a view of at least one section of the area, selecting an object in the received camera frame and labelling the selected object to associate one or more tags with each of the one or more tags being assigned a value. The method further comprises maintaining a library of values assigned to the one or more tags and providing a user interface to allow an operator to select at least one value from the library of values assigned to the one or more tags to filter the corresponding one or more objects associated with the said at least one tag having the selected at least one value, for tracking the corresponding one or more objects in the area.

### TECHNICAL FIELD

The present disclosure relates generally to image processing techniques and more specifically, to a method and a system for tracking objects in an area using image processing techniques.

### BACKGROUND

To operate efficiently, businesses need to have access to inventory information at all times, including the position of each and every object in its facilities. Otherwise, the efficiency of the business will be compromised and it may result in losses. For example, companies such as postal services may lose millions of dollars a year because of items in their warehouses not moving or getting lost. In another example, in the manufacturing industry, there may be objects such as tools and machines which operators may not know are available; and hence, the operators may keep on ordering new ones instead of utilizing the already available facilities. Sometimes, the operators may even lose shipments in its facilities. Thus, companies may need to track objects present in the warehouses, such as shipments, so that the objects do not lie around unutilized.

Traditionally, the objects present in the warehouse may be tracked manually. The tracking of objects such as tools and machines may give the operators an indication of the tools and machines that are already present/available in the warehouse. The operator may thus, not purchase the tools and machines that are already present in the warehouse. Moreover, the tracking of objects may ensure that the shipments are not lost. However, manual tracking of objects may require manual human surveillance. This may be costly and may consume a considerable amount of time. Moreover, manual tracking of objects may be subject to error.

Therefore, in light of the foregoing discussion, there exists a need to overcome the aforementioned drawbacks associated with known techniques for tracking objects in an area.

### SUMMARY

An object of the present disclosure is to provide a method and a system for tracking objects in an area. Another object of the present disclosure is to provide a solution that overcomes at least partially the problems encountered in the known techniques.

In one aspect, an embodiment of the present disclosure provides a method for tracking objects in an area, the method comprising:
receiving a camera frame providing a view of at least one section of the area;
selecting an object in the received camera frame;
labelling the selected object to associate one or more tags therewith, with each of the one or more tags being assigned a value;
maintaining a library of values assigned to the one or more tags; and
providing a user interface to allow an operator to select at least one value from the library of values assigned to the one or more tags to filter the corresponding one or more objects associated with the said at least one tag having the selected at least one value, for tracking the corresponding one or more objects in the area.

In another aspect, an embodiment of the present disclosure provides a system for tracking objects in an area, the system comprising:
an image capturing device configured to capture a camera frame providing a view of at least one section of the area; and
a processing arrangement configured to:
   receive the camera frame from the image capturing arrangement;
   select an object in the received camera frame;
   label the selected object to associate one or more tags therewith, with each of the one or more tags being assigned a value;
   maintain a library of values assigned to the one or more tags; and
   provide a user interface to allow an operator to select at least one value from the library of values assigned to the one or more tags to filter the corresponding one or more objects associated with the said at least one tag having the selected at least one value, for tracking the corresponding one or more objects in the area.

Embodiments of the present disclosure substantially eliminate or at least partially address the aforementioned problems in the prior art and ensure proper tracking of objects in the area.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF DRAWINGS

Embodiments of the present disclosure will now be described, by way of example only, with reference to the following diagrams wherein:

FIG. 1 is a flowchart illustrating steps of a method for tracking objects in an area, in accordance with an embodiment of the present disclosure;

FIG. 2 is an exemplary illustration of a user interface for labelling an exemplary selected object to associate one or more tags therewith, in accordance with an embodiment of the present disclosure;

FIG. 3A is an exemplary illustration of a user interface displaying a history of labelled objects from a plurality of cameras, in accordance with an embodiment of the present disclosure;

FIG. 3B is an exemplary illustration of a user interface for setting a camera of the plurality of cameras of FIG. 3A, in accordance with an embodiment of the present disclosure;

FIG. 3C is an exemplary illustration of a user interface for mapping at least one section of the area to a corresponding portion in a floor plan of the area, in accordance with an embodiment of the present disclosure;

FIG. 4 is an exemplary illustration of a user interface for displaying a list of one or more objects determined to be located in a portion of the floor plan, in accordance with an embodiment of the present disclosure;

FIG. 5A is an exemplary illustration of a user interface for displaying a camera feed of at least one section of the area, in accordance with an embodiment of the present disclosure;

FIG. 5B is an exemplary illustration of a user interface for displaying a history of objects detected in the camera feed, in accordance with an embodiment of the present disclosure; and

FIG. 6 is a block diagram illustration of a system for tracking objects in the area, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for tracking objects in an area, the method comprising:
receiving a camera frame providing a view of at least one section of the area;
selecting an object in the received camera frame;
labelling the selected object to associate one or more tags therewith, with each of the one or more tags being assigned a value;
maintaining a library of values assigned to the one or more tags; and
providing a user interface to allow an operator to select at least one value from the library of values assigned to the one or more tags to filter the corresponding one or more objects associated with the said at least one tag having the selected at least one value, for tracking the corresponding one or more objects in the area.

In another aspect, an embodiment of the present disclosure provides a system for tracking objects in an area, the system comprising:
an image capturing device configured to capture a camera frame providing a view of at least one section of the area; and
a processing arrangement configured to:
   receive the camera frame from the image capturing arrangement;
   select an object in the received camera frame;
   label the selected object to associate one or more tags therewith, with each of the one or more tags being assigned a value;
   maintain a library of values assigned to the one or more tags; and
   provide a user interface to allow an operator to select at least one value from the library of values assigned to the one or more tags to filter the corresponding one or more objects associated with the said at least one tag having the selected at least one value, for tracking the corresponding one or more objects in the area.

It may be appreciated that objects such as shipments, tools, machines and the like may lie around in the warehouses and operators may not be aware of their position at all times. Hence, the shipments may be lost and the tools and machines may mistakenly be purchased again in spite of already being available in the warehouse. In order to rectify the aforesaid problems, some tracking techniques may be employed. The present disclosure relates to a method and a system for tracking objects in an area. Herein, the area may be any premises where the objects to be tracked are placed. The term “area” can be a wide area and is considered to include any or all of an “open” area not otherwise covered by machinery, cabinets or workbenches. An “area” is also considered to include outdoor areas which surround the structure including yards, fields, structure perimeters, and so forth. In an embodiment, the area may be a warehouse where the objects are placed and need to be tracked.

The method comprises receiving a camera frame providing a view of at least one section of the area. Herein, the camera frame may be an image of the at least one section of the area captured by an image capturing device such as a camera. It may be appreciated that often the area may encompass the entire floor of the warehouse or factory and thus be quite large. In such cases, only the section of the area may be captured by the image capturing device. It may be noted that instead of using the single camera, a plurality of cameras may be employed to cover multiple sections of the area in which the objects need to be tracked. Herein, the image capturing device may be configured to an image only setting or a video setting. In case, the image capturing device captures video, the camera frame may be any one of the still images that makes up the video. In some examples, frames from multiple cameras may be stitched together to generate the camera frame without any limitations.

The method further comprises selecting an object in the received camera frame. Herein, the object may include a tool, shipment, machine, chair, basket, person and the like that need to be tracked. Once the camera frame is received, the object may be selected in the camera frame either manually or automatically.

Optionally, selecting the object in the received camera frame comprises defining three or more points along at least two edges of the object in the received camera frame and defining a loop around the object by joining the said three or more points. Herein, first, three or more points may be defined along the at least two edges. Next, the defined points may be joined together to form the loop around the object. In an exemplary embodiment, the selected object may be a chair. Herein, three or more points may be defined along the at least two edges of the said selected chair. The edges may be the edges of a seat, edges of front or rear legs, edges of a top rail and the like of the chair. The three or more points may be joined to form the loop around the chair.

Optionally, selecting the object in the received camera frame comprises designating the object by action of a pointing device over the object in the received camera frame and implementing an edge detection model for estimating edges of the designated object in the received camera frame. It may be appreciated that defining the loop around the object by joining the said three or more points may be time consuming and a laborious task, as the operator may have to define points manually along the edges. In order to reduce time and human dependency, the object may be selected automatically. Herein, the edge detection model may employ one or more of image processing, machine learning and computer vision techniques to detect the edges of the object by finding a gradient of pixel intensity between adjacent pixels. It may be appreciated that the pixel intensity may vary abruptly along the edges giving rise to discontinuities. In such a case, the gradient of pixel intensity between adjacent pixels may be high indicating the presence of edge, for which a boundary of the object may be selected automatically. Such techniques are generally known in the art and thus have not been defined further for the brevity of the present disclosure. In the present implementation, first, the operator may designate the object by positioning a pointer of the pointing device such as a mouse over the object in the received camera frame. Next, the received camera frame with the designated object may be given as an input to the edge detection model. The edge detection model may estimate the edges of the designated object and the object may be selected. That is, herein, the object may be automatically highlighted when the operator hovers or clicks over it and its shape may be automatically detected.

The method further comprises labelling the selected object to associate one or more tags therewith with each of the one or more tags being assigned a value. Herein, the one or more tags may provide information of the selected object. Each tag may be assigned with the value. Once the object is selected, the object may be labelled either manually or automatically. The labelling of the object may be done by clicking on the selected object on a user interface to open a dialogue box. The selected object may be labelled by inputting the one or more tag with their assigned values in the dialogue box of the user interface. For example, the selected object may be the basket and the operator may assign one or more tag as a ‘colour’ of the basket and the value may be ‘red’, for example.

Optionally, the one or more tags comprises at least one of a name, a colour, a height, a width, a length, a weight, a brand, a number of a barcode, of the object. Herein, the tag ‘name’ may associate a name value to the selected object. The value of the tag ‘name’ may be, for example, chair, table, person, basket and the like of the selected object. The value for the tag ‘colour’ may be, for example, one of the colours such as green, blue, grey and the like of the selected object. The values of the tag ‘height’, ‘width’ and ‘length’, may be the dimensions including respective height, respective width and respective length of the selected object. The value of the tag ‘brand’ may be a name of the brand of the selected object, such as 3M®, Apple® and the like of the selected object. The value of the tag ‘number of a barcode’ may be the respective number of the barcode of the selected object.

Optionally, labelling the selected object in the received camera frame comprises configuring the user interface to allow the operator to manually associate one or more tags and assigning respective values thereto. It may be appreciated that the user interface may be an application that may help humans to communicate with a computing device. As discussed, labelling the selected object may be done either manually or automatically. In order to manually label the selected object, the operator may associate one or more tags along with assigning respective values to the selected object via the user interface. For example, if the selected object is chair, the user may manually associate the one or more tags as ‘name’ and ‘colour’ with their assigning respective values as ‘chair’ and ‘black’ respectively, by inputting those tags values in the user interface.

The method further comprises maintaining a library of values assigned to the one or more tags. Herein, the library of values may contain a list of values that have been assigned to the one or more tags. The library of values may be stored in a memory for future references and for automatic labelling of the selected object as discussed in the proceeding paragraphs. For example, the library of values for the tag ‘colour’ may include a list of colours such as, but not limited to, red, green, blue, black, brown, white and the like that the tag ‘colour’ may have been assigned for the selected objects, by an operator using the user interface. Similarly, the library of values for the tag ‘name’ may include a list of object types such as, but not limited to a chair, table, machine, tool and the like that the tag ‘name’ may have been assigned for the selected objects, by an operator using the user interface.

Optionally, labelling the selected object comprises training a machine learning model on the library of values assigned to the one or more tags for each of the objects with the one or more tags associated therewith and implementing the trained machine learning model for automatically associating one or more tags and assigning respective values thereto, with the selected object. Herein, the machine learning model may employ machine learning and artificial intelligence techniques for automatically associating one or more tags along with assigning respective values with the selected object. It may be appreciated that first the machine learning model may need to be trained. The training may be done by using one or more of an unsupervised learning technique, a supervised learning technique and the like. The supervised learning is similar to a teacher student learning. Herein, the machine learning model may be provided with an input data set and an output data set. The machine learning model may learn a rule for mapping each data of the input data set to a corresponding data of the output data set. In unsupervised learning, the machine learning model may be provided with only an input data set. Herein, the machine learning model may learn with experience. In the present implementation, the machine learning model may be provided with the library of values assigned to the one or more tags for its training purposes. The trained machine learning model may then be provided with the selected object as the input for automatically associating one or more tags and assigning respective values thereto, with the selected object. Such implementation of the machine learning model may be contemplated and thus has not been described further.

Optionally, the method further comprises analysing, in real-time, the one or more tags associated with the selected object with the corresponding assigned value for each of the one or more tags; determining one or more potential tags and the corresponding assigned value for each of the one or more potential tags applicable to be associated with the selected object based on the maintained library of values assigned to the one or more tags; and configuring the user interface to suggest to the operator to associate the determined one or more potential tags with the selected object. For example, if previously, the one or more tags associated with the objects being of type chairs include the ‘name’ tag having the assigned value as ‘chair’ and the ‘colour’ tag having the assigned value as ‘brown’, as the operator assigns the ‘name’ tag to another selected object with the assigned value as ‘chair’, herein the given name tag and the assigned value is analysed. Thereafter, the method may determine one or more potential tags and the corresponding assigned value based on the previously assigned values to other tags (other than ‘name’ in the given example). Herein, the one or more potential tags and the corresponding assigned values may be the ‘colour’ tag having the assigned value as ‘brown’. Finally, the method may configure the user interface to suggest to the operator to associate the determined one or more potential tags with the selected object. That is, when the operator assigns the ‘name’ tag to the selected object with the value as ‘chair’, the user interface may suggest the ‘colour’ tag with the assigned value as ‘brown’. Thus, the operator may select the suggested one or more potential tags rather than manually associating them to the selected object.

The method further comprises providing the user interface to allow an operator to select at least one value from the library of values assigned to the one or more tags to filter the corresponding one or more objects associated with the said at least one tag having the selected at least one value, for tracking the corresponding one or more objects in the area.

Herein, the term “tracking” may correspond to either tracking of one or more objects in a video or obtaining a list of one or more objects according to the selected at least one value from the library of values. For example, in an embodiment, the operator may first select at least one value from the library of values assigned to the one or more tags via the user interface. The present method includes filtering the corresponding one or more objects associated with the said at least one tag having the selected at least one value. For instance, if the operator selects at least one value as ‘chair’ for ‘name’ tag and ‘brown’ for the ‘colour’ tag, the present method may involve filtering all the available objects that are ‘chairs’ and are ‘brown’ from the corresponding ‘name’ and ‘colour’ values of tags in the library of values. In the present example, the filtered objects may be displayed in the form of a list in the user interface. In another embodiment, the user interface may provide a camera frame of the at least one section of the area and allow for the operator to apply the filter on the displayed camera frame. Herein, the present method may involve analysing the camera frame to identify the objects with the applied filter value and highlight such objects in the camera frame.

Optionally, the method further comprises receiving a floor plan of the area, mapping each of the at least one section of the area to a corresponding portion in the floor plan of the area, configuring the user interface to allow the operator to select a portion of the floor plan and displaying a list of the one or more objects determined to be located in the at least one section, based on the respective camera frame, in the selected portion of the floor plan. It may be appreciated that the floor plan may be a layout of property such as, but not limited to, a room, a home or a building as seen from above. The method may receive the floor plan of the area and may map each of the at least one section of the area to the corresponding portion in the floor plan of the area using georeferencing techniques. Herein, co-ordinates of each of the at least one section of the area of the camera frame may be mapped to co-ordinate of the corresponding portion in the floor plan of the area. Once mapping is done, the operator may hover over the user interface and may select the portion of the floor plan using selection tools such as the mouse or selection keys, for example by dragging the pointer of the mouse to draw a rectangular shape over a portion of the floor plan. Thereafter, the method may involve determining the list of the one or more objects located in the at least one section corresponding to the selected portion of the floor plan of the respective camera frame. The present method may achieve this using a current position of each of the one or more objects as determined from the respective camera frames (as may be contemplated). The user interface may display the list of the one or more objects located in the at least one section, based on the respective camera frame, in the selected portion of the floor plan. In another example, the user interface may display the cropped camera frame corresponding to the selected portion of the floor plan and highlight the one or more objects located in such cropped camera frame.

The method further comprises receiving a camera feed of the at least one section of the area, analysing the received camera feed to determine a dwell time of each of the one or more objects in the at least one section of the area and configuring the user interface to display the respective dwell time of each the one or more objects. Herein, the camera feed may be a video (series of camera frames) received from the image capturing device. The dwell time may be a time spent by an object that has been stationary in the at least one section of the area. It may be appreciated that each object of the one or more objects may spend an amount of time known as the dwell time in the at least one section of the area. For example, the shipments may be placed in the at least one section of the area before being shipped. In such cases, the dwell time may be the time spent by the shipment in the at least one section of the area before being shipped. The dwell time may be determined by subtracting a time and date at which the object enters the at least one section of the area from a time and date at which the object leaves the at least one section of the area. The processing arrangement may analyse the received camera feed to determine the dwell time of each of the one or more objects in the at least one section of the area. The determined dwell time of each of the one or more objects may be displayed in the user interface along with the list of one or more objects, i.e. the dwell time may be displayed next to the respective object in the list of one or more objects, so that the operator may get quickly check whether any object is lying around for a large amount of time and thus may take required actions accordingly.

Optionally, the method further comprises receiving a camera feed of the at least one section of the area, analysing the received camera feed to determine a movement of each of the one or more objects in the said at least one section of the area and configuring the user interface to display a bounding box over the object of the one or more objects having the determined movement, with the corresponding values of the one or tags associated therewith provided along with the bounding box. For example, in an embodiment, the one or more objects may include personnel moving (walking) in the at least one section of the area. The one or tags associated with the personnel may be the ‘name’ tag to identify the personnel being a foreman, a labourer, a manager or the like. In an example, the assigned value of the ‘name’ tag for particular personnel may be manager. When that particular personnel may be moving in the at least one section of the area, the personnel may be seen in the respective camera feed. The present method may involve analysing the movement of the personnel in the said at least one section of the area and may display the camera feed on the user interface with the bounding box enclosing the personnel to allow for easy identification of some movement. Further, the corresponding values of the one or tags, such as ‘manager’, in the given example, may be displayed along with the bounding box. This may facilitate the operator to take necessary actions, if required. For example, if the at least one section of the area is to be accessed by only managers and not workers, the operator may check the value of the ‘name’ tag displayed on the bounding box to grant or deny access to the at least one section of the area to the personnel based on the checking of the labelled video feed itself. Further, if the personnel may be determined not to be ‘manager’, then the operator may be notified by the user interface to communicate that the personnel shouldn't be allowed to access the at least one section of the area.

Moreover, the present description also relates to the system for tracking objects in an area as described above. The various embodiments and variants disclosed above apply mutatis mutandis to the present system. The present system utilizes an image capturing device to capture a camera frame providing a view of at least one section of the area. The present system further utilizes a processing arrangement to perform the steps as described above related to the disclosed method.

Throughout the present disclosure, the term “processing arrangement” refers to hardware, software, firmware, or a combination of these, for performing specialized data processing tasks of the method. The processing arrangement is a structure and/or module that includes programmable and/or non-programmable components configured to store, process and/or share information or data optimizing image data for generating orthorectified image(s) related to an area of interest in an environment. Optionally, the processing arrangement includes any arrangement of physical or virtual computational entities capable of enhancing information to perform various computational tasks. Further, it will be appreciated that the processing arrangement may be implemented as a hardware processor and/or a plurality of hardware processors operating in a parallel or in a distributed architecture. Optionally, the processors in the processing arrangement are supplemented with additional computation systems such as neural networks and hierarchical clusters of pseudo-analog variable state machines implementing artificial intelligence algorithms. In an example, the processing arrangement may include components such as a memory, a processor, a data communication interface, a network adapter and the like, to store, process and/or share information with other computing devices, such as the data source. Optionally, the processing arrangement includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit, for example as aforementioned. Additionally, the processing arrangement is arranged in various architectures for responding to and processing the instructions for creating training data for an artificial intelligence system to classify hyperspectral data via the system. Optionally, the processing arrangement comprises a plurality of processors for parallel processing of the two or more second image dataset slices. Optionally, the processing arrangement is communicably coupled to a data repository wirelessly and/or in a wired manner. Optionally, the processing arrangement is communicably coupled to the data repository via a data communication network.

The processing arrangement is configured to receive the camera frame from the image capturing arrangement; select an object in the received camera frame; label the selected object to associate one or more tags therewith, with each of the one or more tags being assigned a value; maintain a library of values assigned to the one or more tags; and provide a user interface to allow an operator to select at least one value from the library of values assigned to the one or more tags to filter the corresponding one or more objects associated with the said at least one tag having the selected at least one value, for tracking the corresponding one or more objects in the area.

Optionally, the processing arrangement is further configured to receive a floor plan of the area, map each of the at least one section of the area to a corresponding portion in the floor plan of the area, configure the user interface to allow the operator to select a portion of the floor plan and display a list of the one or more objects determined to be located in the at least one section, based on the respective camera frame, in the selected portion of the floor plan.

Optionally, the processing arrangement is further configured to receive, from the image capturing device, a camera feed of the at least one section of the area, analyse the received camera feed to determine a dwell time of each of the one or more objects in the at least one section of the area and configure the user interface to display the respective dwell time of each the one or more objects.

Optionally, the processing arrangement is further configured to receive, from the image capturing device, a camera feed of the at least one section of the area, analyse the received camera feed to determine a movement of each of the one or more objects in the said at least one section of the area and configure the user interface to display a bounding box over the object of the one or more objects having the determined movement, with the corresponding values of the one or tags associated therewith provided along with the bounding box.

Optionally, the processing arrangement is further configured to analyse, in real-time, the one or more tags associated with the selected object with the corresponding assigned value for each of the one or more tags, determine one or more potential tags and the corresponding assigned value for each of the one or more potential tags applicable to be associated with the selected object based on the maintained library of values assigned to the one or more tags and configure the user interface to suggest to the operator to associate the determined one or more potential tags with the selected object.

The method and system of the present disclosure provide efficient tracking of objects in an area. The present disclosure allows for multiple tags (annotations) to be associated with a single object to allow for filtering and tracking the objects using multiple possible values thereof. Moreover, the system and method may enable labelling the selected object to associate one or more tags with each of the one or more tags being assigned the value, both manually, using the user interface and automatically using the machine learning model. It is possible for automated detection of the properties of an object (e.g. empty, half full, full) or a colour recognition of an object or size of an object (small, medium, big) to be recognized by the trained model. This enables the possibility of an active learning pipeline and the creation of automated documentation and location of objects. As may be contemplated by the person having ordinary skill in the art of facility management, the teachings of the present disclosure could be applied for automated creation of risk maps, cost maps, and potential maps for a given facility. Furthermore, the system and method may assist the operator to take action by displaying the dwell time of the one or more objects. The system and method may also display the bounding box with the corresponding values of the one or tags associated over the object having the determined movement on the user interface which may further assist the operator in taking appropriate actions.

### DETAILED DESCRIPTION OF DRAWINGS

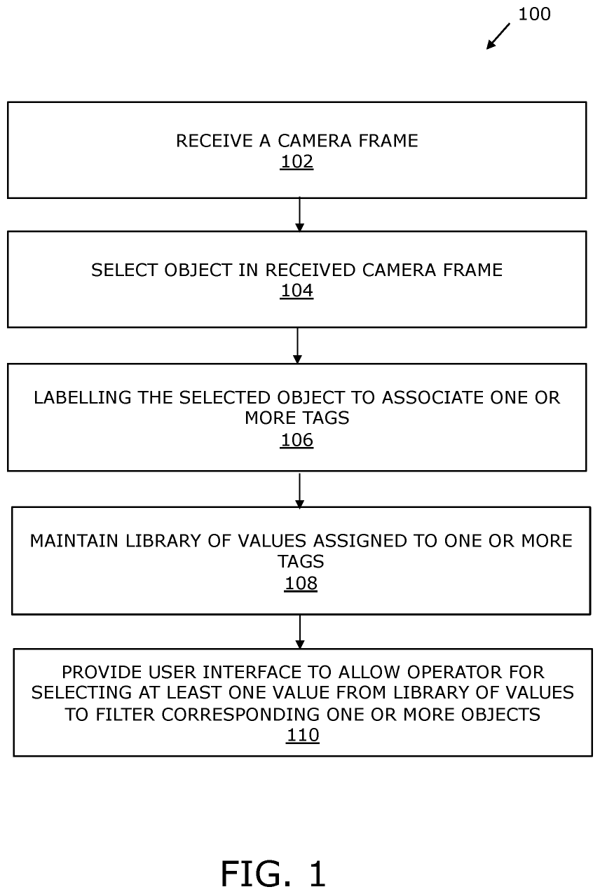

FIG. 1 is a flowchart illustrating steps of a method 100 for tracking objects in an area, in accordance with an embodiment of the present disclosure. The method 100 includes, at step 102, receiving a camera frame. Herein, the camera frame providing a view of at least one section of the area is received. The method 100 includes, at step 104, selecting an object in the received camera frame. The method 100 includes, at step 106, labelling the selected object to associate one or more tags therewith, with each of the one or more tags being assigned a value. The method 100 includes, at step 108, maintaining a library of values assigned to the one or more tags. The method 100 includes, at step 110, providing a user interface to allow an operator to select at least one value from the library of values assigned to the one or more tags to filter the corresponding one or more objects associated with the said at least one tag having the selected at least one value, for tracking the corresponding one or more objects in the area.

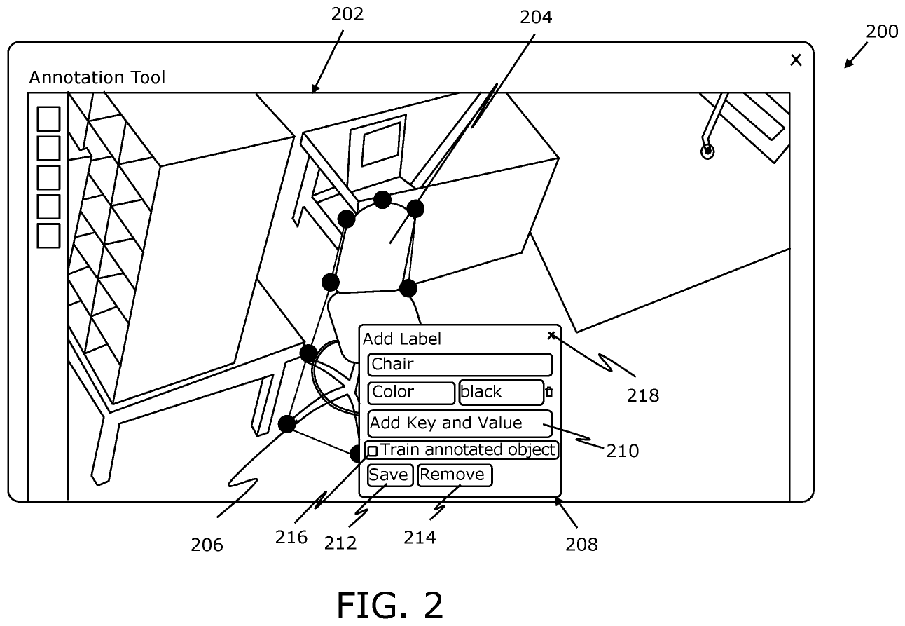

Referring to FIG. 2, there is shown an exemplary illustration of a user interface 200 for labelling an exemplary selected object to associate one or more tags, in accordance with an embodiment of the present disclosure. Herein, the exemplary selected object is a chair 204. The user interface 200 displays a received camera frame 202. The chair 204 is selected by defining three or more points, such as points 206, along at least two edges of the chair 204. The defined points 206 are joined to form a loop around the chair 204. When selected, a dialogue box 208 is opened on the user interface 200 to associate one or more tags to the chair 204. It may be observed from FIG. 2 that an operator could manually add the one or more tags. In the illustrated example, ‘name’ and ‘colour’ tags are selected and the assigned value of the ‘name’ tag is ‘chair’ and the assigned value of the ‘colour’ tag is black. In order to add more tags, the operator may select an add key and value button 210. Once the one or tags are assigned to the object (i.e. chair 204, in this example), the operator may select a save button 212 to associate the one or more tags along with assigning respective values to the object. In order to remove the associated one or more tags the operator may select a remove button 214. The operator may optionally train a machine learning model on the values assigned to the one or more tags for the object by clicking on a train check box 216. Finally, the operator may close the dialogue box 208 by selecting a close button 218.

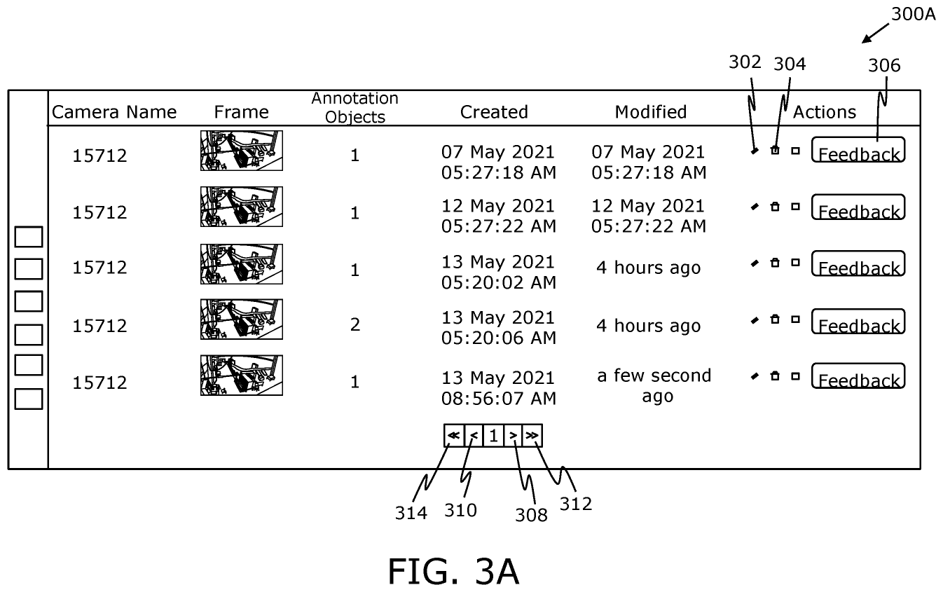

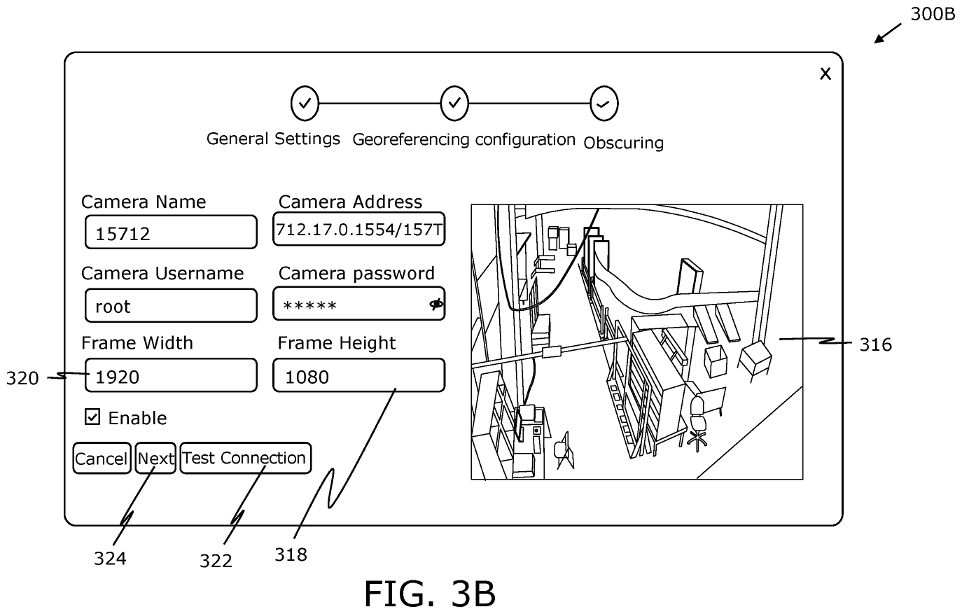

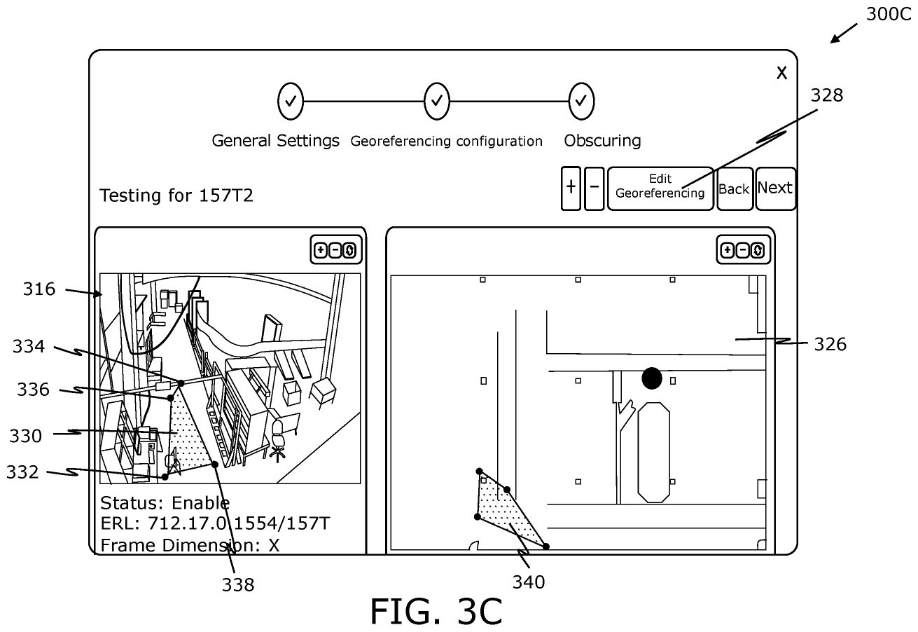

Referring to FIG. 3A, there is shown an exemplary illustration of a user interface 300A displaying a history of labelled objects from a plurality of camera frames, in accordance with an embodiment of the present disclosure. The user interface 300A displays a name of each camera of the plurality of cameras from which the listed camera frames are received. The camera frame for each camera of the plurality of cameras is shown across the corresponding camera. A number of objects that have been labelled in each camera frame are shown in ‘Annotation Objects’ column. Columns namely ‘Created’ and ‘Modified’, respectively, provide a time at which the labelling of object was done for the corresponding camera frame and a time at which the labelling of object for the corresponding camera frame was last modified (if so). The operator may edit the labelled object by selecting a corresponding edit button 302, delete the corresponding camera frame by selecting a corresponding delete button 304 and provide a feedback for the corresponding camera frame by selecting a corresponding feedback button 306. It may be noted that all history of labelled objects may not be shown at once on the user interface 300A. The user interface 300A may also include a forward button 308 to show history of other labelled objects next in the list and a backward button 310 to go back to previous history of labelled objects. The user interface 300A may also include a fast forward button 312 and a fast backward button 314, to jump to the last and first page respectively.

Referring to FIG. 3B, there is shown an exemplary illustration of a user interface 300B for setting-up a camera of the plurality of cameras of FIG. 3A, in accordance with an embodiment of the present disclosure. The user interface 300B is obtained when the operator selects the edit button 302 corresponding to the camera, for example having the camera name as ‘15712’ of FIG. 3A. The user interface 300B depicts a camera frame 316 received from the camera having the camera name as ‘15712’. The camera having the camera name as ‘15712A’ may be configured by entering a camera username and password. A camera frame height and a camera frame width may be set by entering corresponding values in a frame height field 318 and a frame width field 320 respectively. After entering the camera username, the camera password, the camera frame height and the camera frame width, the said camera having the camera name as ‘15712’ may be tested by selecting a test connection button 322. On clicking the test connection button 322, the camera frame 316 may be displayed on the user interface 300B. By selecting a next button 324 a user interface for a georeferencing configuration may be accessed.

Referring to FIG. 3C, there is shown an exemplary illustration of a user interface 300C for mapping each at least one section of the area to a corresponding portion in a floor plan 326 of the area, in accordance with an embodiment of the present disclosure. By selecting a next button 324 of the user interface 300B of FIG. 3B, the user interface 300C may be accessed. The user interface 300C displays a floor plan 326 of the area. A first button 328 may toggle between an edit georeferencing mode and an exit editing mode. First, the first button 328 may be clicked to select the edit georeferencing mode option. Herein, each of at least one section of the area may be mapped to a corresponding portion in the floor plan 326 of the area. For example, an area 330 of the camera frame 316 selected by joining points 332, 334, 336 and 338 is mapped to a corresponding portion 340 in the floor plan 326 of the area. Once, each of the at least one section of the area is mapped to the corresponding portion in the floor plan 326 of the area, the first button 328 may be selected again to enter the exit editing mode.

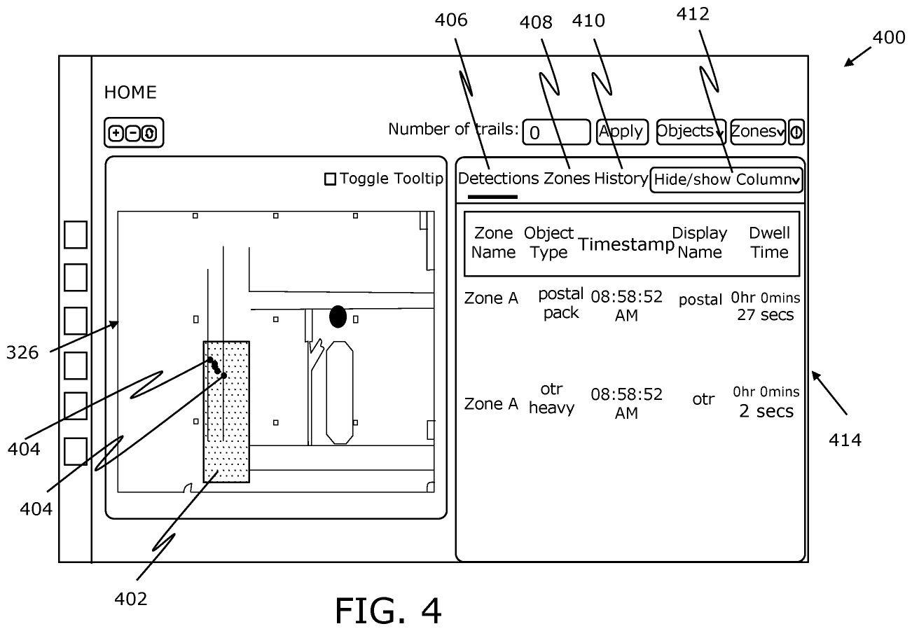

Referring to FIG. 4, there is shown an exemplary illustration of a user interface 400 for displaying a list of the one or more objects 414 determined to be located in a portion 402 of the floor plan 326, in accordance with an embodiment of the present disclosure. Herein, the operator may select a portion 402 of the floor plan 326. The list of the one or more objects 414 determined to be located in the portion 402 is displayed on the user interface 400. The list of the one or more objects 414 includes all objects that may have been detected in the portion 402 corresponding to the at least one section of the area. The list of the one or more objects 414 displayed on the user interface 400 also gives an information about an object type, a timestamp which represents time at which the object is detected, a display name and a dwell time for each object. A location of each object of the list of the one or more objects 414 may be shown on the floor plan 326 by means of dots 404. A complete list of the one or more objects 414 is displayed by selecting a detection button 406. A list of the one or more objects according to zones may be displayed by selecting a zones button 408. A list of the one or more objects according to a history is displayed by selecting a history button 410. Herein, the history may be a certain time duration for which the operator wishes to obtain the list of the one or more objects 414 determined to present in the selected portion 402. A hide/show column button 412 may be selected to hide or show the list of the one or more objects 414.

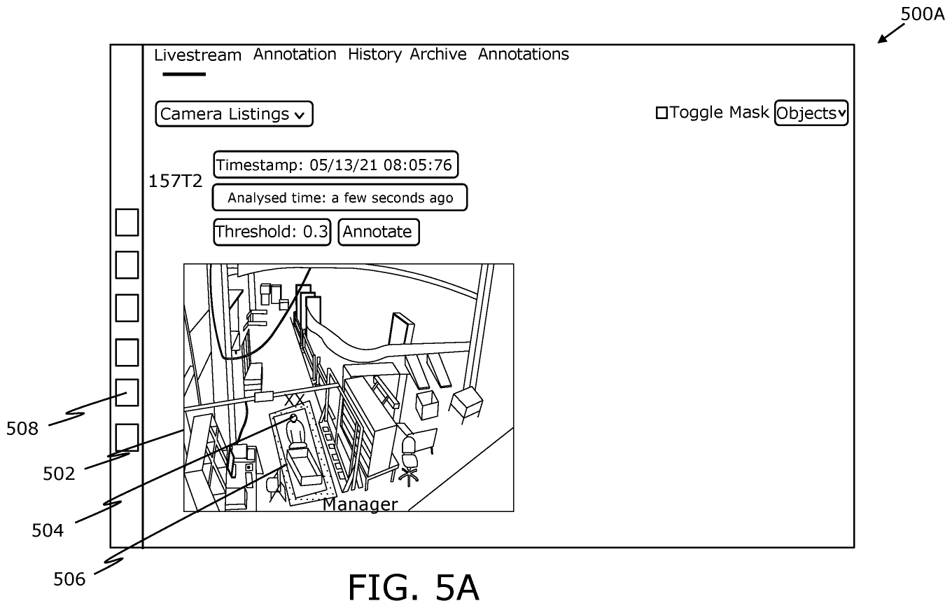

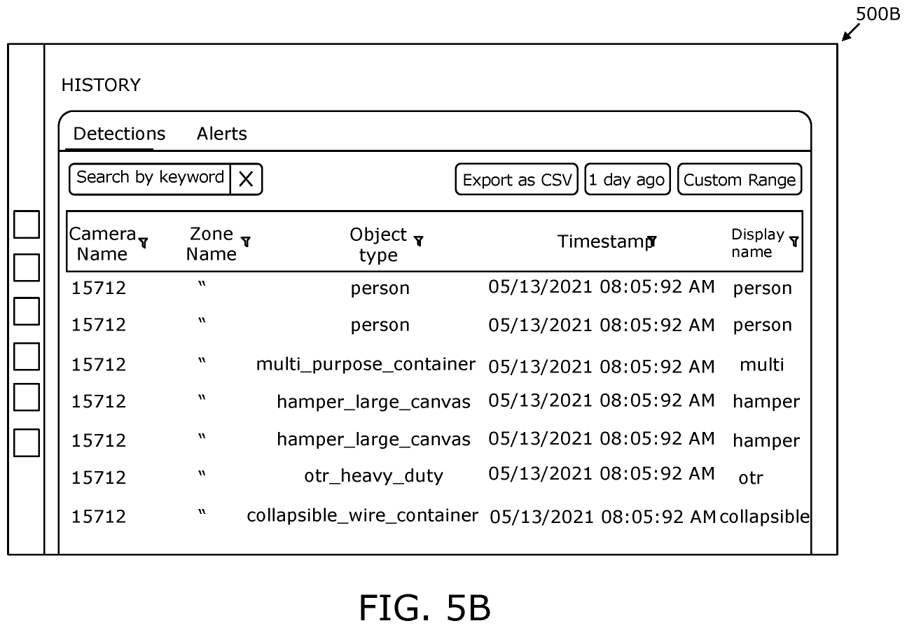

Referring to FIG. 5A, there is shown an exemplary illustration of a user interface 500A for displaying a camera feed 502 of at least one section of the area, in accordance with an embodiment of the present disclosure. The camera feed 502 may be analysed to determine a dwell time of each of the one or more objects in the at least one section of the area. In the exemplary illustration, the object includes personnel 504 moving with a trolley. The personnel 504 is shown enclosed in a bounding box 506 in the camera feed for reference of the operator. The user interface 500A displays the corresponding values of the one or more tags associated with the personnel along with the bounding box 506, again for reference of the operator. As seen from FIG. 5A, the one or more tags associated with the personnel 504 includes a ‘name’ tag having the assigned value as ‘manager’. By selecting a button 508 a history of objects detected in the camera feed 502 may be displayed.

Referring to FIG. 5B, there is shown an exemplary illustration of a user interface 500B for displaying a history of objects detected in the camera feed 502, in accordance with an embodiment of the present disclosure. Herein, a name of zone, object type, timestamp and display name are also depicted for each object.

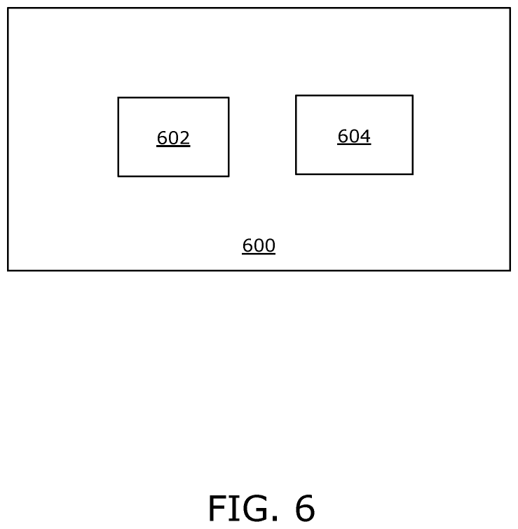

Referring to FIG. 6, there is shown a block diagram illustration of a system 600 for tracking objects in an area, in accordance with an embodiment of the present disclosure. The system 600 comprises an image capturing device 602 and a processing arrangement 604. The image capturing device 602 is configured to capture a camera frame providing a view of at least one section of the area. The processing arrangement 604 is configured to receive the camera frame from the image capturing arrangement, select an object in the received camera frame, label the selected object to associate one or more tags therewith, with each of the one or more tags being assigned a value, maintain a library of values assigned to the one or more tags and provide a user interface to allow an operator to select at least one value from the library of values assigned to the one or more tags to filter the corresponding one or more objects associated with the said at least one tag having the selected at least one value, for tracking the corresponding one or more objects in the area.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

1. A method for tracking objects in an area, the method comprising:
receiving a camera frame providing a view of at least one section of the area;
selecting an object in the received camera frame;
labelling the selected object to associate one or more tags therewith, with each of the one or more tags being assigned a value;
maintaining a library of values assigned to the one or more tags; and
providing a user interface to allow an operator to select at least one value from the library of values assigned to the one or more tags to filter the corresponding one or more objects associated with the said at least one tag having the selected at least one value, for tracking the corresponding one or more objects in the area.

2. A method according to claim 1, wherein selecting the object in the received camera frame comprises:
defining three or more points along at least two edges of the object in the received camera frame; and
defining a loop around the object by joining the said three or more points.

3. A method according to claim 1, wherein selecting the object in the received camera frame comprises:
designating the object by action of a pointing device over the object in the received camera frame; and
implementing an edge detection model for estimating edges of the designated object in the received camera frame.

4. A method according to claim 1, wherein labelling the selected object in the received camera frame comprises configuring the user interface to allow the operator to manually associate one or more tags and assigning respective values thereto.

5. A method according to claim 1, wherein labelling the selected object comprises:
training a machine learning model on the library of values assigned to the one or more tags for each of the objects with the one or more tags associated therewith; and
implementing the trained machine learning model for automatically associating one or more tags and assigning respective values thereto, with the selected object.

6. A method according to claim 1, further comprising:
receiving a floor plan of the area;
mapping each of the at least one section of the area to a corresponding portion in the floor plan of the area;
configuring the user interface to allow the operator to select a portion of the floor plan; and
displaying a list of the one or more objects determined to be located in the at least one section, based on the respective camera frame, in the selected portion of the floor plan.

7. A method according to claim 1, further comprising:
receiving a camera feed of the at least one section of the area;
analysing the received camera feed to determine a dwell time of each of the one or more objects in the at least one section of the area; and
configuring the user interface to display the respective dwell time of each the one or more objects.

8. A method according to claim 1, further comprising:
receiving a camera feed of the at least one section of the area;
analysing the received camera feed to determine a movement of each of the one or more objects in the said at least one section of the area; and
configuring the user interface to display a bounding box over the object of the one or more objects having the determined movement, with the corresponding values of the one or tags associated therewith provided along with the bounding box.

9. A method according to claim 1, further comprising:
analysing, in real-time, the one or more tags associated with the selected object with the corresponding assigned value for each of the one or more tags;
determining one or more potential tags and the corresponding assigned value for each of the one or more potential tags applicable to be associated with the selected object based on the maintained library of values assigned to the one or more tags; and
configuring the user interface to suggest to the operator to associate the determined one or more potential tags with the selected object.

10. A method according to claim 1, wherein the one or more tags comprises at least one of: a name, a colour, a height, a width, a length, a weight, a brand, a number of a barcode, of the object.

11. A system for tracking objects in an area, the system comprising:
an image capturing device configured to capture a camera frame providing a view of at least one section of the area; and
a processing arrangement configured to:
receive the camera frame from the image capturing arrangement;
select an object in the received camera frame;
label the selected object to associate one or more tags therewith, with each of the one or more tags being assigned a value;
maintain a library of values assigned to the one or more tags; and
provide a user interface to allow an operator to select at least one value from the library of values assigned to the one or more tags to filter the corresponding one or more objects associated with the said at least one tag having the selected at least one value, for tracking the corresponding one or more objects in the area.

12. A system according to claim 11, wherein the processing arrangement is further configured to:
receive a floor plan of the area;
map each of the at least one section of the area to a corresponding portion in the floor plan of the area;
configure the user interface to allow the operator to select a portion of the floor plan;
display a list of the one or more objects determined to be located in the at least one section, based on the respective camera frame, in the selected portion of the floor plan.

13. A system according to claim 11, wherein the processing arrangement is further configured to:
receive, from the image capturing device, a camera feed of the at least one section of the area;
analyse the received camera feed to determine a dwell time of each of the one or more objects in the at least one section of the area; and
configure the user interface to display the respective dwell time of each of the one or more objects.

14. A system according to claim 11, wherein the processing arrangement is further configured to:
receive, from the image capturing device, a camera feed of the at least one section of the area;
analyse the received camera feed to determine a movement of each of the one or more objects in the said at least one section of the area; and
configure the user interface to display a bounding box over the object of the one or more objects having the determined movement, with the corresponding values of the one or tags associated therewith provided along with the bounding box.

15. A system according to claim 11, wherein the processing arrangement is further configured to:
analyse, in real-time, the one or more tags associated with the selected object with the corresponding assigned value for each of the one or more tags;
determine one or more potential tags and the corresponding assigned value for each of the one or more potential tags applicable to be associated with the selected object based on the maintained library of values assigned to the one or more tags; and
configure the user interface to suggest to the operator to associate the determined one or more potential tags with the selected object.
